(19) United States
(12) Patent Application Publication
(10) Pub. No.: US 2006/0034880 A1
(43) Pub. Date: Feb. 16, 2006

(54) Cleaning and disinfecting composition

(75) Inventors: Delford Ian Christmas, Montvale, NJ (US); Ramakrishnan Hariharan, Montvale, NJ (US); Robert Zhong Lu, Montvale, NJ (US)

Correspondence Address: NORRIS, MCLAUGHLIN & MARCUS, 875 THIRD AVE, 18TH FLOOR, NEW YORK, NY, 10022, US

(73) Assignee: Reckitt Benckiser Inc, Parsippany,, NJ (US)

(21) Appl. No.: 10/530,926

(22) PCT Filed: Oct. 10, 2003
(86) PCT No.: PCT/GB03/04419

§ 371 Date: Apr. 8, 2005

(30) Foreign Application Priority Data
Oct. 12, 2002 (GB) 0223837.6

(51) Int. Cl. A01N 25/00

(52) U.S. Cl. 424/405

(57) ABSTRACT

The present invention provides a non-cationic antimicrobial agent containing composition which blooms when added to water. The compositions have good cleaning, disinfecting and bloom properties.

The present invention is directed to concentrated cleaning and/or disinfecting compositions which bloom when diluted in water.

Cleaning compositions are commercially important products and enjoy a wide field of utility in assisting in the removal of dirt and grime from surfaces, especially those characterized as useful with hard surfaces. One particular category of cleaning compositions are those which provide a blooming effect. Such an effect may be described as the change of the water's appearance from essentially colorless and transparent to that of a milky white or milky yellowish white, cloudy appearance upon the addition of an amount of the cleaning composition. This effect is also sometimes referred to as the “break”. Such blooming is a highly desirable in such pine oil type cleaning compositions as consumer/end user expectations associate cleaning effectiveness with the extent and degree of this blooming upon formation of a cleaning composition. Such an effect is particularly known and generally associated with pine oil type cleaning compositions which typically include one or more of the following identifying characteristics: containing an amount of one or more resins or oils derived from coniferous species of trees; containing natural fragrances or synthetic fragrance compositions which are intended to mimic the scent of one or more resins or oils derived from coniferous species of trees; a color ranging from colorless to a deep amber, deep amber yellow or deep amber reddish color; generation of a milky or cloudy appearance when diluted with water in dilutions useful for cleaning applications. Such pine oil type cleaning compositions are generally provided in a concentrated composition which is subsequently diluted with water by an end user/consumer to form a cleaning composition therefrom.

Thus, the present invention provides a hard surface cleaning concentrate composition comprising:
a) from about 0.05 to about 15 wt %, preferably from about 0.1 to about 8 wt %, and more preferably from about 0.2 to about 6 wt % of at least one non-cationic antimicrobial agent;
b) from about 0.1 to about 20 wt %, preferably from about 0.5 to about 15 wt %, and more preferably from about 1 to about 15 wt % of at least one solvent selected from water soluble organic solvent, water insoluble organic solvent, terpene, essential oil, and mixtures thereof;
c) from about 0.1 to about 20 wt %, preferably from about 0.5 to about 15 wt %, and more preferably from about 1 to about 10 wt % of an anionic soap surfactant;
d) from about 0.01 to about 10 wt %, preferably from about 0.05 to about 8 wt %, and more preferably from about 0.1 to about 5 wt % of at least one surfactant selected from nonionic surfactant, anionic surfactant excluding the anionic soap of c), and mixtures thereof;
e) optionally, from about 0.1 to about 10 wt % of one or more alkanolamines;
f) optionally, from about 0 to about 10 wt % of one or more conventional constituents selected from dyes, colorants, fragrances and fragrance solubilizers/enhancers, light stabilizers, viscosity modifying agents, pH adjusting agents and pH buffers including organic and inorganic salts, optical brighteners, opacifying agents, hydrotropes, antifoaming agents, enzymes, anti-spotting agents, anti-oxidants, preservatives, and anti-corrosion agents; and
g) the balance, water.

The present invention also concerns a process for cleaning and/or disinfecting a hard surface requiring such treatment which process includes the steps of:

dispersing in water in a weight ratio of concentrate composition:water of from 1:0.1 to 1:1000 a composition according to the present invention; and

applying the dispersed concentrate to the hard surface in an amount effective for providing cleaning and/or disinfecting treatment of the hard surface.

Preferably, the non-cationic antimicrobial agent is one or more non-cationic antimicrobial agent selected from pyrithiones, dimethyldimethylol hydantoin, methylchloroisothiazolinone/methylisothiazolinone sodium sulfite, sodium bisulfite, imidazolidinyl urea, diazolidinyl urea, benzyl alcohol, 2-bromo-2-nitropropane-1,3-diol, formalin (formaldehyde), iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal dichlorobenzyl alcohol, captan, chlorphenenesin, dichlorophene, chlorbutanol, glyceryl laurate, halogenated diphenyl ethers, phenolic compounds, mono- and poly-alkyl and aromatic halophenols, resorcinol and its derivatives, bisphenolic compounds, benzoic esters (parabens), halogenated carbanilides, 3-trifluoromethyl-4,4′-dichlorocarbanilide, and 3,3′,4-trichlorocarbanilide. More preferably, the non-cationic antimicrobial agent is a mono- and poly-alkyl and aromatic halophenol selected from the group p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, dichloro meta xylenol, chlorothymol, and 5-chloro-2-hydroxydiphenylmethane.

According to certain especially preferred embodiments, the concentrate compositions may be characterized in that when the concentrate compositions are diluted at a ratio of 1 part to 50-200 parts water at 20° C., the resultant mixture exhibits a light transmittance loss of at least 30%. In particularly preferred embodiments the concentrate compositions do not form a gel at usual storage conditions (room temperature, approximately 20° C.), and exhibit a satisfactory blooming effect when added to a larger volume of water where such water is at room temperature. According to preferred embodiments, the concentrate compositions cause a drop in transmitted light through water of at least 20%, more desirably at least about 30% and more when used to form a cleaning composition therefrom, particularly at a dilution of 1 part cleaning concentrate to 50 parts water relative to the transmittance of water, which is established to be 100%. According to particularly preferred embodiments the concentrate compositions cause a drop in transmitted light through water of at least about 40% when added to water at 20° C. Most preferred are compositions which exhibit a drop in transmitted light of at least 60% when added to water at 20° C., wherein the dilutions of concentrate composition to water is 1:50.

The antimicrobial agents of the present invention are non-cationic in order to avoid interaction with the anionic soap surfactant of the invention. Given below are examples of non-cationic antimicrobial agents which are particularly useful in the present invention: pyrithiones (especially zinc pyrithione which is also known as ZPT), dimethyldimethylol hydantoin (Glydant®), methylchloroisothiazolinone/methylisothiazolinone (Kathon CG®), sodium sulfite, sodium bisulfite, imidazolidinyl urea (Germall 115®), diazolidinyl urea (Germaill II®, benzyl alcohol, 2-bromo-2-nitropropane-1,3-diol (Bronopol®), formalin (formaldehyde), iodopropenyl butylcarbamate (Polyphase P100®, chloroacetamide, methanamine, methyldibromonitrile glutaronitrile (1,2-Dibromo-2,4-dicyanobutane or Tektamer®), glutaraldehyde, 5-bromo-5-nitro-1,3-dioxane (Bronidox®), phenethyl alcohol, o-phenylphenol/sodium o-phenylphenol, sodium hydroxymethylglycinate (Suttocide A®), polymethoxy bicyclic oxazolidine (Nuosept C®), dimethoxane, thimersal dichlorobenzyl alcohol, captan, chlorphenenesin, dichlorophene, chlorbutanol, glyceryl laurate, halogenated diphenyl ethers like 2,4,4′-trichloro-2′-hydroxy-diphenyl ether (Triclosan® or TCS), 2,2′-dihydroxy-5,5′-dibromo-diphenyl ether, phenolic compounds like phenol, 2-methyl phenol, 3-methyl phenol, 4-methyl phenol, 4-ethyl phenol, 2,4-dimethyl phenol, 2,5-dimethyl phenol, 3,4-dimethyl phenol, 2,6-dimethyl phenol, 4-n-propyl phenol, 4-n-butyl phenol, 4-n-amyl phenol, 4-tert-amyl phenol, 4-n-hexyl phenol, 4-n-heptyl phenol, mono- and poly-alkyl and aromatic halophenols such as p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, dichloro meta xylenol, chlorothymol, 5-chloro-2-hydroxydiphenylmethane, resorcinol and its derivatives including methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol, p-chlorobenzyl resorcinol, 5-chloro 2,4-dihydroxydiphenyl methane, 4′-chloro 2,4-dihydroxydiphenyl methane, 5-bromo 2,4-dihydroxydiphenyl methane, and 4′-bromo 2,4-dihydroxydiphenyl methane, bisphenolic compounds like 2,2′-methylene bis (4-chlorophenol), 2,2′-methylene bis (3,4,6-trichlorophenol), 2,2′-methylene bis (4-chloro-6-bromophenol), bis (2-hydroxy-3,5-dichlorophenyl) sulphide, and bis (2-hydroxy-5-chlorobenzyl)sulphide, benzoic esters (parabens) like methylparaben, propylparaben, butylparaben, ethylparaben, isopropylparaben, isobutylparaben, benzylparaben, sodium methylparaben, and sodium propylparaben, halogenated carbanilides (e.g., 3,4,4′-trichlorocarbanilides (Triclocarban® or TCC), 3-trifluoromethyl-4,4′-dichlorocarbanilide, 3,3′,4-trichlorocarbanilide, etc.). The phenol based non-cationic antimicrobials are preferred. The non-cationic antimicrobial agent in the present invention is present in an amount from about 0.05 to about 15 wt %, preferably from about 0.1 to about 8 wt %, and more preferably from about 0.2 to about 6 wt %.

Another constituent is a solvent selected from water-soluble organic solvents, water insoluble organic solvents, essential oils, and mixtures thereof.

Examples of water-soluble organic solvents include short chain (e.g., C₁-C₄) alcohols, glycol ethers, and mixtures thereof. Such water soluble organic solvents provide effective solubilization of many types of greases and fats which may be encountered in soils, as well as being useful in the solubilization of the pine oil in water, without substantially interfering with the blooming and scent characteristics of the compositions according to the present invention. Examples of short chain alcohols include ethanol, propanol, and isopropanol. Examples of such useful glycol ethers include propylene glycol methyl ether, dipropylene glycol methyl ether, tripropylene glycol methyl ether, propylene glycol n-propyl ether, diethylene glycol methyl ether, ethylene glycol butyl ether, diethylene glycol methyl ether, and mixtures thereof.

Examples of essential oils include for example, Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Bomeol Flakes (China), Camphor oil, White, Camphor powder synthetic technical, Cananga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin 69° C. (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), Wintergreen, Allocimene, Arbanex™, Arbanol®), Bergamot oils, Camphene, Alpha-Campholenic aldehyde, I-Carvone, Cineoles, Citral, Citronellol Terpenes, Alpha-Citronellol, Citronellyl Acetate, Citronellyl Nitrile, Para-Cymene, Dihydroanethole, Dihydrocarveol, d-Dihydrocarvone, Dihydrolinalool, Dihydromyrcene, Dihydromyrcenol, Dihydromyrcenyl Acetate, Dihydroterpineol, Dimethyloctanal, Dimethyloctanol, Dimethyloctanyl Acetate, Estragole, Ethyl-2 Methylbutyrate, Fenchol, Fernlo™, Florilys™, Geraniol, Geranyl Acetate, Geranyl Nitrile, Glidmint™ Mint oils, Glidox™, Grapefruit oils, trans-2-Hexenal, trans-2-Hexenol, cis-3-Hexenyl Isovalerate, cis-3-Hexanyl-2-methylbutyrate, Hexyl Isovalerate, Hexyl-2-methylbutyrate, Hydroxycitronellal, Ionone, Isobornyl Methylether, Linalool, Linalool Oxide, Linalyl Acetate, Menthane Hydroperoxide, I-Methyl Acetate, Methyl Hexyl Ether, Methyl-2-methylbutyrate, 2-Methylbutyl Isovalerate, Myrcene, Nerol, Neryl Acetate, 3-Octanol, 3-Octyl Acetate, Phenyl Ethyl-2-methylbutyrate, Petitgrain oil, cis-Pinane, Pinane Hydroperoxide, Pinanol, Pine Ester, Pine Needle oils, Pine oil, alpha-Pinene, beta-Pinene, alpha-Pinene Oxide, Plinol, Plinyl Acetate, Pseudo Ionone, Rhodinol, Rhodinyl Acetate, Spice oils, alpha-Terpinene, gamma-Terpinene, Terpinene-4-OL, Terpineol, Terpinolene, Terpinyl Acetate, Tetrahydrolinalool, Tetrahydrolinalyl Acetate, Tetrahydromyrcenol, Tetralol®, Tomato oils, Vitalizair, Zestoral™, as well as certain extracts from the various oils such as d-limonene (found in pine and citrus oils).

Pine oils can be further broken down as a constituent that includes terpenes which include a large number of related alcohols or ketones. Some important constituents include terpineol, which is one of three isomeric alcohols having the basic molecular formula C₁₀H₁₇OH. One type of pine oil, synthetic pine oil, will generally have a specific gravity, at 15.5° C. of about 0.9300, which is lower than the two other grades of pine oil, namely steam distilled and sulfate pine oils, and will generally contain a higher content of turpentine alcohols. Other important compounds include alpha- and beta-pinene (turpentine), abietic acid (rosin), and other isoprene derivatives.

Presently commercially available pine oils include Unipine® 60 (from Union Camp, believed to contain approximately 60% terpene alcohols), Unipine® S-70 and Unipine® S-70 (both are believed to contain approximately 70% terpene alcohols), Unipine® S and Unipine® 80 (both are believed to contain approximately 80% terpene alcohols), Unipine® 85 (which is believed to contain approximately 85% terpene alcohols), Unipine® 90 (which is believed to contain approximately 90% terpene alcohols), as well as Alpha Terpineol 90 (which is believed to contain approximately 100% terpene alcohols). Further useful pine oils include Glidco® Pine Oil™ 60 (available from Glidco Organics Corp., Jacksonville, Fla., believed to contain approximately 60% terpene alcohols), Glidco® Pine Oil 140 (believed to contain approximately 70% terpene alcohols), Glidco® Pine Oil 80 (believed to contain approximately 80% terpene alcohols), Glidco® Pine Oil 150 (believed to contain approximately 85% terpene alcohols); Glidco® Terpene SW (believed to contain approximately 75% terpene alcohols); as well as Glidco® Terpineol 350 (believed to contain approximately 100% terpene alcohols). Other products which can contain up to 100% pure alpha-terpineol, may also be used in the present invention. When used, pine oil are those pine oils which comprise at least about 60% terpene alcohols, and more preferably those which comprise at least about 80% terpene alcohols

Another example of water insoluble organic solvents includes fatty acid methyl ester solvents which include (or consist solely of) significant portions of one or more fatty acid methyl esters. The fatty acid methyl ester solvents are based on formulas having the structure

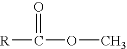

wherein R is a fatty alkyl moiety such as C6-C32, especially a C8-C24 alkyl moiety. These solvents may be based on a single monoester of a fatty acid or on a blend of fatty acid monoesters. The fatty acid may be saturated, unsaturated, or polyunsaturated. Exemplary esters, without limitation, include methyl linoleate, methyl linolenate and monoesters of any of a number of vegetable oils. Such vegetable oils are the commonly available vegetable triglycerides in which the preponderance of the fatty acid ester moieties have a chain length of 12 or more carbon atoms, particularly having a chain length of 16 or more carbon atoms. Exemplary vegetable oils include those that can be derived from soybean, cottonseed, linseed, safflower, corn, sunflower, sesame, tung, canola (rapseed). Exemplary vegetable oil methyl esters derived from such sources include linseed oil methyl ester, safflower oil methyl ester, tung oil methyl ester, and soybean oil methyl ester. Additional examples of fatty acid methyl esters include those derived from various fractions of coconut oils such as C₈-C₁₀ methyl esters, C₁₂ methyl esters and C₁₄ methyl esters.

Fatty acid methyl esters from synthetic sources may also be used. Examples of synthetic ester oils include isopropyl myristate, cetyl octanate, octyldodecyl myristate, isopropyl palmitate, butyl stearate, hexyl laurate, myristyl myristate, decyl oleate, hexyldecyl dimethyloctanate, cetyl lactate, myristyl lactate, lanolin acetate, isocetyl stearate, isocetyl isostearate, cholesteryl 12-hydroxystearate, ethylene glycol di-2-ethythexylate, dipentaerythritol fatty acid ester, N-alkylglycol monoisostearate, neopentylglycol dicaproate, diisostearyl malate, glycerin di-2-heptyl undecanoate, trimethylpropane-tri-2-ethylhexylate, trimethylopropane triisostearate, pentaerythritol tetra-2-ethylhexylate, glycerin tri-2-ethylhexylate, cetyl-2-ethyhexanoate, 2-ethylhexyl palmitate, glycerin trimyristate, glyceride tri-2-heptylundecanoate, castor oil fatty acid methyl ester, cetostearyl alcohol, acetoglyceride, 2-heptylundecyl palmitate, diisobutyl adipate, N-lauroyl-L-glytamate-2-octyl dodecyl ester, di-2-heptylundecyl adipate, ethyl laurate, di-2-ethylhexyl sebatate, 2-hexyldecyl myristate, 2-hexyldecyl palmitate, 2-hexyldecyl adipate, diisopropyl sebatate, 2-ethylhexyl succinate, and the like. One example of fatty acid methyl ester solvent is available under tradename Soygold, a soybean oil methyl ester solvent available from Ag Environmental Products Co. Another example is derived from coconut oil under the Emery tradename (Henkel) and available in three chain lengths of C₈-C₁₀ (Emery 2209); C₁₂ (Emery 2296); and C₁₄ (Emery 2214).

For the present invention, the solvent constituent is present in an amount of from about 0.1 to about 20 wt %, preferably from about 0.5 to about 15 wt %, and more preferably from about 1 to about 15 wt %.

Anionic soap surfactants represent the primary detergent component in the present compositions of interest. This class of surfactants includes ordinary alkali metal soaps such as the sodium, potassium, ammonium and alkanol-ammonium salts of higher fatty acids containing from about 8 to about 24 carbon atoms and preferably from about 10 to about 20 carbon atoms. Suitable fatty acids can be obtained from natural sources such as, for instance, plant or animal esters (e.g., palm oil, coconut oil, babassu oil, soybean oil, castor oil, tallow, whale and fish oils, grease, lard, and mixtures thereof). The fatty acids also can be synthetically prepared (e.g., by the oxidation of petroleum, or by the Fischer-Tropsch process). Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful is the sodium or potassium salt of the mixtures of fatty acids derived from castor oil, i.e., sodium castor oil soap. The anionic soap surfactant in the present invention comprises an amount from about 0.1 to about 20 wt %, preferably from about 0.5 to about 15 wt %, and more preferably from about 1 to about 10 wt %.

The present invention also contains a surfactant selected from nonionic surfactants, anionic surfactants excluding the anionic soap of c), and mixtures thereof.

Nonlimiting examples of suitable nonionic surfactants which may be used in the present invention are as follows:

(1) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

(2) The condensation products of aliphatic alcohols with from about I to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). One example of such a nonionic surfactant is available as Empilan KM 50.

(3) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):
HO-(EO)ₓ(PO)_{y}(EO)_{z}-H (A)
where EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants appropriate for use in the new compositions can be represented by the formula (B):
R-(EO,PO)ₐ(EO,PO)_{b}-H (B)
wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:
RO-(BO)ₙ(EO)ₓ-H (C)
wherein R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):
HO-(EO)ₓ(BO)ₙ(EO)_{y}-H (D)
wherein n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula: 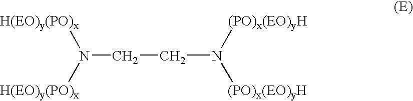
where (EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Other nonionic surfactants include short chain non-ionic surfactants. The short chain non-ionic surfactant is one which has from six to eleven carbon atoms in the non-polar hydrophobic portion of the surfactant.

Examples of short chain non-ionic surfactants include linear alcohol ethoxylates. The linear alcohol ethoxylates which may be employed in the present invention are generally the C₆-C₁₁ straight-chain alcohols which are ethoxylated with from about 3 to about 6 moles of ethylene oxide. Their derivation is well known in the art. Examples include Alfonic® 810-4.5, which is described in product literature from Condea Vista as having an average molecular weight of 356, an ethylene oxide content of about 4.85 moles (about 60 wt. %), and an HLB of about 12; Alfonic® 810-2, which is described in product literature from Condea Vista as having an average molecular weight of 242, an ethylene oxide content of about 2.1 moles (about 40 wt. %), and an HLB of about 12; and Alfonic® 610-3.5, which is described in product literature from Condea Vista as having an average molecular weight of 276, an ethylene oxide content of about 3.1 moles (about 50 wt. %), and an HLB of 10. Product literature from Condea Vista also identifies that the numbers in the alcohol ethoxylate name designate the carbon chain length (numbers before the hyphen) and the average moles of ethylene oxide (numbers after the hyphen) in the product.

Other examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule.

Other examples include those surfactants having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename available from Clariant, Charlotte, N.C., include the 26-L series of the general formula RO(CH₂CH₂OₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

Further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630. Other examples are available under the following tradenames: Lutensol AO7 (C13-15, 7 moles) from BASF and Galaxy MW259 (Lauryl Alcohol Ethoxylates—9 moles) from Galaxy Surfactants Ltd.

Other examples of ethoxylated nonionic surfactants include alkyl phenol ethoxylates, for example, ethoxylated nonylphenols sold as Igepal CO-630 (Chem Service, Inc.), Tergitol NP-9 (Union Carbide) and Surfonic N-95 (Texaco).

Examples of anionic surfactants such as alkali metal salts, ammonium salts, amine salts, aminoalcohol salts or the magnesium salts of one or more of the following compounds: alkyl sulfates, alkyl ether sulfates, alkylamidoether sulfates, alkylaryl polyether sulfates, alkylaryl sulfates, alkylaryl sulfonates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

For the present invention, the surfactant selected from nonionic surfactants, anionic surfactants excluding the anionic soap of c), and mixtures thereof is present in an amount of from about 0.01 to about 10 wt %, preferably from about 0.05 to about 8 wt %, and more preferably from about 0.1 to about 5 wt %.

An optional, but preferred, constituent in the present invention is an alkanolamine, such as, for example monoethanolamine.

As the concentrate compositions are aqueous, water forms a major constituent. Water is added in order to provide 100 wt % of the concentrate composition. The water may be tap water, but is preferably distilled and/or deionized water. If the water is tap water, it is preferably appropriately filtered in order to remove any undesirable impurities such as organics or inorganics, especially mineral salts which are present in hard water which may thus interfere with the operation of the other constituents of the invention, as well as any other optional components of the liquid concentrates according to the invention.

Water is added in amounts which are sufficient to form the concentrated compositions which amount is sufficient to ensure the retention of a substantially clear characteristic when produced as a concentrate, but at the same time ensuring good blooming upon the addition of the concentrated composition to a further amount of water, or upon the addition of further water to the concentrate. This amount may be readily determined by first mixing measured amount of the non-water constituents in a suitably sized vessel and then during stirring adding water. Generally, water is present in the concentrate compositions in amounts in excess of about 50 wt %, preferably in amounts of in excess of about 70 wt %, but most preferably in amount of between 80-90 wt % based on the total weight of the concentrate compositions according to the invention.

As noted previously, the concentrate compositions according to the invention may include further optional, but advantageously included constituents.

Useful optional constituents are one or more coloring agents which find use in modifying the appearance of the concentrate compositions and enhance their appearance from the perspective of a consumer or other end user. Known coloring agents, may be incorporated in the compositions in effective amount to improve or impart to concentrate compositions an appearance characteristic of a pine oil type concentrate composition, such as a color ranging from colorless to brown to yellow to purple color with or without fluorescent ingredients. Such a coloring agent or coloring agents may be added in any useful amount in a conventional fashion, i. e., admixing to a concentrate composition or blending with other constituents used to form a concentrate composition. However, other colors atypical of pine oil type and/or lemon oil type cleaning concentrates may be used as well. Known art light stabilizer constituents useful in pine oil type compositions may also be added, particularly wherein coloring agents are used in a composition. As is known to the art, such light stabilizers act to retain the appearance characteristics of the concentrate compositions over longer intervals of time.

Further useful optional constituents which may in some cases be desirably included in the inventive compositions include rheology modifying agents such as thickeners.

Other conventional additives known to the art but not expressly enumerated here may also be included in the compositions according to the invention. By way of non-limiting example these may include fragrance/fragrance adjusters (which do not interfere with any pine oil constituent of the present invention, when present and which can generally be present in an amount of from about 0.000001 to about 1.5 wt % of the total concentrate, whether pine oil based or non-pine oil based), pH adjusters, pH buffering agents, non-ionic surfactants and insect repellants. Such non-ionic surfactants denoted here are conventionally known; examples are described in McCutcheon's Detergents and Emulsifiers, North American Edition, 2001; Kirk-Othmer, Encyclopedia of Chemical Technology, 4th Ed., Vol. 23, pp. 478-541, the contents of which are herein incorporated by reference. Such optional constituents should be selected so to have little or no detrimental effect upon the desirable characteristics of the present invention, namely the blooming behavior, cleaning efficacy, and disinfectant activity, low toxicity as provided by the inventive compositions. Generally the total weight of such further conventional additives may comprise up to 10 wt % of a concentrated composition formulation.

What is to be understood by the term “concentrate” and “concentrate composition” in this specification and claims is the pre-consumer dilution and composition of the cleaning composition which is the essentially the form of the product prepared for sale to the consumer or other end user. Such a consumer or other end user would then normally be expected to dilute the same with water to form a cleaning composition. It is to be understood however that nothing in this invention would bar its use as cleaning composition without any further dilution and it may be used in the concentrations in which it was prepared for sale. Similarly, what is to be understood by the term “cleaning compositions” are the water diluted compositions which are expected to be prepared by the consumer or other end user by mixing a measured amount of the “concentrate” with water in order to form an appropriately diluted cleaning composition which is suitable for use in cleaning applications, especially in the cleaning of hard surfaces.

It is also to be understood, that proportions of one or more constituents have been and generally are referred to as percent by weight or as parts by weight based on a measure of 100% by weight, unless otherwise indicated.

As generally denoted above, the formulations according to the invention include both cleaning compositions and concentrates as outlined above which differ only in the relative proportion of water to that of the other constituents forming such formulations. While the concentrated form of the cleaning compositions find use in their original form, they are more frequently used in the formation of a cleaning composition therefrom. Such may be easily prepared by diluting measured amounts of the concentrate compositions in water by the consumer or other end user in certain weight ratios of concentrate:water, and optionally, agitating the same to ensure even distribution of the concentrate in the water. As noted, the concentrate may be used without dilution, i.e., in concentrate:water concentrations of 1:0, to extremely dilute dilutions such as 1:1-1:1000, preferably in the range of 1:5-1:500 but most preferably in the range of 1:10-1:100. The actual dilution selected is in part determinable by the degree and amount of dirt and grime to be removed from a surface(s), the amount of mechanical force imparted to remove the same, as well as the observed efficacy of a particular dilution. Generally better results and faster removal is to be expected at lower relative dilutions of the concentrate in water.

### EXAMPLES

Preparation of Example Formulations:

Exemplary formulations illustrating certain preferred embodiments of the inventive compositions and described in more detail in Table I below were formulated generally in accordance with the following protocol.

Into a suitably sized vessel, a measured amount of the non-cationic antimicrobial agent (e.g., PCMX, DCMX) was provided after which the remaining organic based components (e.g., hydrocarbon diluent, pine oil, water soluble organic solvent, dye (if any)). These components were stirred until the non-cationic antimicrobial agent was fully dissolved. The anionic soap surfactant solution is then added to the organic solution and the components are stirred until the mixture is homogeneous. The remaining amount of water is then added to the organic/anionic soap surfactant mixture and the components are then mixed until the solution is clear and homogeneous. Mixing of the various components at the various times can range from 5 minutes to 120 minutes; the amount of time can vary so long as particular solutions appeared to be homogeneous. The exemplary compositions were readily pourable, and retained well mixed characteristics (i.e., stable mixtures), even at elevated temperatures up to 120° F., upon standing for extended periods, even in excess of 90 days.

Examples of inventive formulations are shown in Table 1 below.

TABLE 1

| | Ex.1 | Ex.2 | Ex.3 | Ex.4 | Ex.5 | Ex.6 | Ex.7 | Ex.8 | | |
|---|---|---|---|---|---|---|---|---|---|---|
| Component | Wt % | Wt % | Wt % | Wt % | Wt % | Wt % | Wt % | Wt % | | |
| OBPCP | 1.05 | 0.90 | 1.05 | | | | 0.25 | 0.25 | | |
| PCMX | | | | 2.00 | 3.50 | 3.00 | 0.45 | 0.45 | | |
| Pine Oil | 6.00 | 6.00 | 5.00 | 6.00 | 1.50 | | 1.50 | 1.25 | | |
| Nonene | | | | | | | | | | |
| Mineral Spirits | | | | | | | | | | |
| d-Limonene | | | | | | | | 0.75 | | |
| IPA | 1.00 | 2.00 | 2.00 | 5.00 | 3.00 | 1.00 | | | | |
| Ethanol | | | | | | | 1.00 | 1.00 | | |
| Caster Oil Soap | 20.00 | 12.00 | 16.00 | 15.00 | 20.00 | 20.00 | 8.00 | 8.00 | | |
| Tergitol NP-9 | | 2.00 | 1.50 | 1.50 | 1.50 | 3.00 | | | | |
| Bio-soft D40 | 4.00 | | | | | | | | | |
| Rhodapon LCP | | | | | | | 1.60 | 2.00 | | |
| Triphosphate | | | 0.45 | | | | | | | |
| Dye (1%) | | | | | | | | | | |
| Fragrance | | | | | 0.35 | 0.30 | 0.12 | | | |
| DI Water | 67.95 | 77.10 | 74.00 | 70.50 | 70.15 | 72.70 | 87.08 | 86.30 | | |
| | Ex.9 | Ex.10 | Ex.11 | Ex.12 | Ex.13 | Ex.14 | Ex.15 | Ex.16 | Ex.17 | |
| Ingredient | Wt % | Wt % | Wt % | Wt % | Wt % | Wt % | Wt % | Wt % | Wt % | |
| DI Water | 73.30 | 73.25 | 73.05 | 73.30 | 72.50 | 72.00 | 71.20 | 75.05 | 75.10 | |
| CastorOil Soap | 18.00 | 18.00 | 18.00 | 18.00 | 20.00 | 20.00 | 20.00 | 18.00 | 18.00 | |
| Pine Oil | 4.00 | 4.00 | 4.00 | 4.00 | 3.00 | 4.00 | 3.00 | 3.00 | 3.00 | |
| OBPCP | 1.20 | 1.20 | 1.20 | | | | | | | |
| PCMX | | | | 1.20 | 1.20 | 1.20 | 1.50 | 1.00 | 0.95 | |
| Odorless Mineral | | | | | | | | | | |
| Ethanol | | 1.00 | 1.00 | | 1.00 | 1.00 | 1.00 | | | |
| IPA | 2.00 | | | 1.00 | | | | 1.00 | 1.00 | |
| Rhodapon LCP | | | | | | | | | | |
| Alcohol ethoxylates | | | | | | | | 0.70 | 0.70 | |
| Monoethanolamine | | 1.00 | 1.00 | 1.00 | 1.00 | 1.00 | 1.00 | 0.75 | 0.75 | |
| Tergitol NP-9 | 1.00 | 1.00 | 1.00 | 1.00 | 1.00 | 0.50 | 2.00 | | | |
| Fragrance | 0.35 | 0.35 | 0.35 | 0.35 | 0.30 | 0.30 | 0.30 | 0.35 | 0.35 | |
| Dye | 0.15 | 0.20 | 0.40 | 0.15 | | | | 0.15 | 0.15 | |
| | Ex.18 | Ex.19 | Ex.20 | Ex.21 | Ex.22 | Ex.23 | Ex.24 | Ex.25 | Ex.26 | Ex.27 |
| Component | Wt % | Wt % | Wt % | Wt % | Wt % | Wt % | Wt % | Wt % | Wt % | Wt % |
| OBPCP | | 1.00 | 0.95 | 0.90 | 1.15 | 1.20 | 1.20 | 1.10 | 1.10 | 1.10 |
| PCMX | 0.90 | | | | | | | | | |
| Pine Oil | 3.00 | 3.00 | 3.00 | 3.00 | 3.00 | 3.00 | 4.00 | 3.50 | 3.50 | 3.00 |
| IPA | 1.00 | 1.00 | 1.00 | 1.00 | 1.00 | 1.00 | 1.00 | 1.00 | 1.00 | 1.00 |
| Monoethanolamine | 0.75 | 0.75 | 0.75 | 0.75 | 0.75 | 0.75 | 1.00 | | 0.40 | 0.75 |
| Caster Oil Soap | 18.00 | 18.00 | 18.00 | 18.00 | 18.00 | 18.00 | 18.00 | 18.00 | 18.00 | 18.00 |
| Alcohol ethoxylates | 0.70 | 0.70 | 0.70 | 0.70 | 0.70 | 0.70 | 0.70 | 0.50 | 0.50 | 0.50 |
| Dye | 0.15 | 0.15 | 0.15 | 0.15 | 0.15 | 0.15 | 0.15 | 0.15 | 0.15 | 0.15 |
| Fragrance | 0.35 | 0.35 | 0.35 | 0.35 | 0.35 | 0.35 | 0.35 | 0.35 | 0.35 | 0.35 |
| DI Water | 75.15 | 75.05 | 75.10 | 75.15 | 74.90 | 74.85 | 73.60 | 75.40 | 75.00 | 75.15 |

The identity of the specific constituents of Table 1 are indicated on Table 2.

TABLE 2
Component

| | |
|---|---|
| OBPCP | Orthobenzyl-para-chlorophenol |
| PCMX | p-Chloro-m-xylene |
| Pine Oil | Pine oil (60, 80 or 85) |
| d-Limonene | d-Limonene |
| IPA | Isopropanol |
| Ethanol | Ethanol |
| Caster Oil Soap (35-40%) | Sodium castor oil soap (35-40%) |
| Tergitol NP-9 | Nonylphenol ethoxylates (9 moles EO) |
| Bio-soft D40 (40%) | Sodium dodecylbenzene sulfonate |
| Rhodapon LCP (30%) | Sodium lauryl sulfate |
| Alcohol ethoxylate | Examples: Lutensol AO7 (C₁₃₋₁₅, 7 moles; |
| | BASF); Galaxy MW259 (Lauryl Alcohol |
| | Ethoxylates - 9 moles; Galaxy Surfactants |
| | Ltd) |
| Triphosphate | Triphosphate |
| Dye | Dye (Active 1%) |
| Fragrance | Fragrance |
| DI Water | Distilled water |

Compositions of the present invention were evaluated for cleaning and disinfecting properties.

Cleaning Evaluation

Cleaning evaluations for greasy soils were performed in accordance with the testing protocol outlined according to ASTM D4488 A2 Test Method, which evaluated the efficacy of the cleaning compositions on masonite wallboard samples painted with wall paint. The soil applied was a greasy soil sample containing vegetable oil, food shortening and animal fat. The sponge (water dampened) of a Gardner Abrasion Tester apparatus was squirted with a 15 gram sample of a tested cleaning composition, and the apparatus was cycled 10 times. The evaluation of cleaning compositions was “paired” with one side of each of the test samples treated with a composition according to the invention, and the other side of the same sample treated with a comparative example's composition, thus allowing a “side-by-side” comparison to be made. Each of these tests were duplicated on at least 5 wallboard tiles and the results statistically analyzed and the averaged results reported on Table 3, below. The cleaning efficacy of the tested compositions was evaluated utilizing a Minolta Chroma Meter CF-110, with Data Processor DP-100, which evaluated spectrophotomic characteristics of the sample.

Cleaning evaluation for oily soil was evaluated on diluted compositions under the protocol of ASTM D-4488-89 Annex A5 for particulate soil, which evaluated the efficacy of the cleaning compositions on vinyl tile samples. The soil applied was a particulate soil sample containing natural humus, paraffin oil, used crankcase motor oil, Portland cement, silica, lampblack carbon, iron oxide, bandy black clay, stearic acid, and oleic acid produced according to the protocol. Each of the soiled test vinyl tile samples were placed into the apparatus and the center of each tile was wetted with a 20 milliliter sample of a test formulation and allowed to stand for 1 minute. When approximately 30 seconds had elapsed, a further 50 milliliter sample was applied to the sponge (water dampened, then wrung to remove excess water) of a Gardner Abrasion Tester apparatus. Thereafter the apparatus was cycled 10 times, which provided 20 strokes of the sponge across the face of each of the vinyl test tiles. The reflectance values of the cleaned samples at 10 cycles were evaluated utilizing a Minolta Chroma Meter CF-110, with Data Processor DP-100, which evaluated spectrophotomic characteristics of the sample.

Evaluation of Antimicrobial Efficacy

Representative compositions of the present invention were evaluated in order to evaluate their antimicrobial efficacy against Staphylococcus aureus (Staph) and Escherichia coli (E. coli). The evaluation was done using the “Non-Food Contact Sanitizer Method, Sanitizer Test” (for inanimate, non-food contact surfaces), created from EPA DIS/TSS-10, 7 Jan. 1982. The results of this evaluation are summarized in Table 3 below.

TABLE 3

| | | | | | | |
|---|---|---|---|---|---|---|
| Ex.9 | Ex.10 | Ex.11 | Ex.12 | Ex.13 | Ex.14 | Ex.15 |

Micro Efficacy (1:50, 10 mins)

| | | | | | | | |
|---|---|---|---|---|---|---|---|
| E. Coli | 4.01 | 5.65 | 5.65 | 6.65 | | | |
| Staph | 3.2 | 3.64 | 3.64 | 3.87 | 5.05 | 5.05 | 3.77 |

Cleaning Efficacy

| Cleaning (Greasy, neat) | 91.13% | 90.20% | 90.20% | | | | |
|---|---|---|---|---|---|---|---|
| Cleaning (Oily soil, | | | | | 15.47% | 7.17% | 14.94% |
| 1:50 dilution) | | | | | | | |
| | Ex.16 | Ex.17 | Ex.18 | Ex.19 | Ex.20 | Ex.21 | |

Micro Efficacy (1:50, 10 mins)

| | | | | | | |
|---|---|---|---|---|---|---|
| E. Coli | 3.26 | 3.12 | 2.70 | Fail | Fail | Fail |
| Staph | 5.10 | 5.24 | 5.05 | 5.28 | 6.27 | 5.97 |

Cleaning Efficacy

| Cleaning (Greasy, neat) | 85.05% | | | | | |
|---|---|---|---|---|---|---|
| Cleaning (Oily soil, | | | | | | |
| 1:50 dilution) | | | | | | |
| | Ex.22 | Ex.23 | Ex.24 | Ex.25 | Ex.26 | Ex.27 |

Micro Efficacy (1:50, 10 mins)

| | | | | | | |
|---|---|---|---|---|---|---|
| E. Coli | Fail | Fail | 4.24 | 3.02 | 3.79 | 3.27 |
| Staph | 6.12 | 6.47 | 5.95 | 5.95 | 5.95 | 5.95 |

Cleaning Efficacy

| | |
|---|---|
| Cleaning (Greasy, neat) | 82.87% |
| Cleaning (Oily soil, | |
| 1:50 dilution) | |

As generally denoted above, the formulations according to the invention include both cleaning compositions and concentrates as outlined above which differ only in the relative proportion of water to that of the other constituents forming such formulations. While the concentrated form of the cleaning compositions find use in their original form, they are more frequently used in the formation of a cleaning composition therefrom. Such may be easily prepared by diluting measured amounts of the concentrate compositions in water by the consumer or other end user in certain weight ratios of concentrate:water, and optionally, agitating the same to ensure even distribution of the concentrate in the water. As noted, the concentrate may be used without dilution, i.e., in concentrate:water concentrations of 1:0, to extremely dilute dilutions such as 1:1000, preferably in the range of 1:1-1:500 but most preferably in the range of 1:10-1:100. The actual dilution selected is in part determinable by the degree and amount of dirt and grime to be removed from a surface(s), the amount of mechanical force imparted to remove the same, as well as the observed efficacy of a particular dilution. Generally better results and faster removal is to be expected at lower relative dilutions of the concentrate in water.

Evaluation of Light Transmittance (“Blooming”) of Formulations

Certain of the formulations described on Table 1 were evaluated to determine the degree of light transmittance, which conversely provided a measure of the opacity of each of the aqueous dilutions. The results of the light transmittance evaluation was determined as a percentage of light transmitted through a sample of a particular aqueous dilution wherein the transmission of a like sample of water is assigned a percentage of 100%. Testing was performed by preparing either a 1:100 or 1:200 dilution of the example formulation:water, (tap water) after which the sample was mixed for 30 seconds and a transmittance reading was taken using a Brinkman model PC801 dipping probe calorimeter, which was set at 620 nm to determine the light transmission of each of the samples. Readings taken at a water temperature of 20° C. were evaluated, as well as the reference (pure tap water) sample used to calibrate the colorimeter to the reference 100% light transmission sample outlined above. The resulting determined values are reported in Table 4 which results provide an empirical evaluation of the degree of transparency of a diluted example formulation wherein 0% indicates complete opacity and 100% the transparency of the sample. Accordingly, a lower reported light transmittance value of a particular aqueous dilution provided a more desirable indication of the blooming characteristic of the particular aqueous dilution. The results are shown in Table 4.

TABLE 4

| Example | 1:200 Dilution | 1:100 Dilution |
|---|---|---|
| (Control) Tap | 100% | 100% |
| Ex.10 | 5.0% | 0.8% |
| Ex.11 | 8.3% | 1.1% |
| Ex.12 | 31.2% | 9.3% |
| Ex.16 | 29.0% | 9.0% |
| Ex.26 | 4.3% | 0.8% |
| Ex.9 | 3.2% | 0.6% |

1. A hard surface cleaning concentrate composition comprising:
a) at least one non-cationic antimicrobial agent;
b) at least one solvent selected from water soluble organic solvent, water insoluble organic solvent, terpenes, essential oil, and mixtures thereof;
c) an anionic soap surfactant;
d) at least one surfactant selected from nonionic surfactant, anionic surfactant excluding the anionic soap of c), and mixtures thereof;
e) optionally, one or more alkanolamines;
f) optionally, one or more conventional constituents selected from dyes, colorants, fragrances and fragrance solubilizers/enhancers, light stabilizers, viscosity modifying agents, pH adjusting agents and pH buffers including organic and inorganic salts, optical brighteners, opacifying agents, hydrotropes, antifoaming agents, enzymes, anti-spotting agents, anti-oxidants, preservatives, and anti-corrosion agents; and
g) the balance, water
characterized in that the concentrate compositions are mixed with water in dilution of 1 part concentrate composition to 50-200 parts water at 20° C., the resultant mixture exhibits a light transmittance loss of at least 30%.

2. The cleaning concentrate according to claim 1 wherein the a) non-cationic antimicrobial agent is selected from pyrithiones, dimethyldimethylol hydantoin, methylchloroisothiazolinone/methylisothiazolinone sodium sulfite, sodium bisulfite, imidazolidinyl urea, diazolidinyl urea, benzyl alcohol, 2-bromo-2-nitropropane-1,3-diol, formalin (formaldehyde), iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal dichlorobenzyl alcohol, captan, chlorphenenesin, dichlorophene, chlorbutanol, glyceryl laurate, halogenated diphenyl ethers, phenolic compounds, mono- and poly-alkyl and aromatic halophenols, resorcinol and its derivatives, bisphenolic compounds, benzoic esters (parabens), halogenated carbanilides, 3-trifluoromethyl-4,4-dichlorocarbanilide, and 3,3,4-trichlorocarbanilide.

3. The cleaning concentrate according to claim 1 wherein the a) non-cationic antimicrobial agent is a mono- and poly-alkyl and aromatic halophenol selected from the group p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-methylphenol, para-chloro-meta-xylenol, dichloro meta xylenol, chlorothymol, and 5-chloro-2-hydroxydiphenylmethane.

4. The composition according to claim 1 wherein the b) solvent is selected from C₁₋₄ alcohols, terpenes, essential oil, and mixtures thereof.

5. The composition according to claim 1 wherein the b) solvent is a mixture of essential oil and C₁₋₄ alcohol.

6. (canceled)

7. (canceled)

8. (canceled)

9. (canceled)

10. The composition according to claim 5 wherein the b) solvent is a mixture of essential oil and ethanol.

11. The composition according to claim 5 wherein the essential oil is a mixture of pine oil and d-limonene.

12. The composition according to claim 1 wherein the anionic soap surfactant is selected from alkali metal soap fatty acids containing from about 8 to about 24 carbon atoms.

13. The composition according to claim 12 wherein the anionic soap surfactant is selected from alkali metal soap fatty acids.

14. The composition according to claim 1 wherein the non-cationic antimicrobial agent is present in an amount of from about 0.05 to about 15 wt %.

15. The composition according to claim 1 wherein the anionic soap surfactant is present in an amount of from about 0.1 to about 20 wt %.

16. The composition according to claim 1 wherein the d) surfactant is a mixture of nonionic surfactant and anionic surfactant excluding the anionic soap of c).

17. The composition according to claim 1 wherein the d) surfactant is nonionic surfactant.

18. The composition according to claim 1 wherein the d) surfactant is an anionic surfactant excluding the anionic soap of c).

19. The composition according to claim 16 wherein the nonionic surfactant is an alcohol ethoxylate.

20. The composition according to claim 19 wherein the alcohol ethoxylate is an alkylphenol ethoxylate.

21. The composition according to claim 16 wherein the anionic surfactant excluding the anionic soap of c) is a sulfate or sulfonate.

22. (canceled)

23. (canceled)

24. The composition according to claims 1 to 23 wherein the d) surfactant is present in an amount of from about 0.01 to about 10 wt %.

25. The composition according to claim 1 which contain e) at least one alkanolamine.

26. (canceled)

27. (canceled)

28. (canceled)

29. (canceled)

30. A process for cleaning and/or disinfecting a hard surface requiring such treatment which process includes the steps of:
dispersing in water in a weight ratio of concentrate composition:water of from 1:0.1 to 1:1000 a composition according to claim 1; and
applying the dispersed concentrate to the hard surface in an amount effective for providing cleaning and/or disinfecting treatment of the hard surface.
